(19) United States
(12) Patent Application Publication
(10) Pub. No.: US 2006/0096860 A1
(43) Pub. Date: May 11, 2006

(54) Analyte recognition system

(76) Inventors: Israel Mayer Stein, Chestnut Hill, MA (US); Gerardus Williebrordus Giesen, Zutphen (NL); Jagan Mohan Rao, Moorestown, NJ (US); Richard Dennis Driver, Cambridge, MA (US)

Correspondence Address: Kenneth J. LuKacher, Esq., South Winton Court, 3136 Winton Road South, Suite 204, Rochester, NY, 14623, US

(21) Appl. No.: 10/985,315

(22) Filed: Nov. 10, 2004

(51) Int. Cl. G01N 27/26

(52) U.S. Cl. 204/409; 204/400

(57) ABSTRACT

An analyte recognition system uses an array (16) of ion-selective electrode (ISE) sensors, each sensitive to a different ion in a downstream flow path (32) therethrough to a coupling (30) which provides a ground or bias electrode. Another flow path (34) is upstream through an ISE sensor (26) which provides a reference electrode and the coupling. The coupling has a flow path, provided by a sidearm, to an outlet (40) going to a drain (35) for both the upstream and downstream flow paths. The upstream flow path reference electrode is a conduit for a reference fluid, and measurements from the other electrodes are made with respect to the reference electrode. Contamination and permanent poisoning of certain of the electrodes in the downstream path may occur if reversal of the flow were to take place, or if the reference fluid flowing in the upstream path were to flow into the downstream path. Reversal of flow is prevented by inclusion of a one-way valve, desirably a duckbill valve (75) in the coupling in the downstream path to the sidearm. Poisoning of the ISE sensors is prevented because the duckbill valve reduces the likelihood of a reversal of the normal downstream flow and reduces flow of the reference fluid in the upstream direction through the array of ion-selective electrodes.

The present invention relates to analyte recognition systems and particularly analyte recognition systems incorporating ion-selective electrodes (ISEs) which are operative with a reference electrode. The analyte recognition system is improved in accordance with the invention by allowing unidirectional flow and preventing a reversal of flow through the ion-selective electrodes thereby preventing contamination or poisoning thereof.

Ion-selective electrodes, which are preferred may be of the type stored in dry condition. Such ISEs are described in U.S. Pat. No. 5,013,421, issued May 7, 1991, to Rao et al. and are available commercially from Clinical Data Inc. of Newton, Mass., USA. These electrodes may be made sensitive to different ions in analytes, especially the ions potassium (K), sodium (Na), chloride (Cl), and carbonate (CO₂) which are present in human serum or plasma. The measurements of these analytes for the presence of ions are made with respect to a reference ISE electrode. The ion-selective electrodes may be packaged with the reference electrode and a coupling electrode (also called ground or bias electrode) in a module. Such modules and systems for use thereof for the analysis of sera or other body fluids are available from Clinical Data Inc. A T-junction in the coupling between the reference electrode and the other ion-selective electrodes results in either sample or reference fluid flowing in a downstream direction through the ISEs which are sensitive for the K, Na, Cl, and CO₂ ions and the reference solution flowing in an upstream direction through the reference electrode. The reference fluid and the sample fluid exit through a side-arm of the T coupling in the ground electrode.

It has been discovered that if reversal of the downstream flow were to take place, certain electrodes of the module system are subject to contamination and poisoning of by contaminants released by the other electrodes, such as the CO₂ sensitive ISE at the bottom of the stack of ISE's in the module and carried in the opposite direction by the sample stream or the reference fluid to the K sensitive ISE. Such contaminants are carried by a reversal of fluid flow, which instead of going to the outlet and proceeding to drain, leaks in the upstream direction through the ion selective ISEs. Such leakage can cause such contamination and permanent poisoning of certain electrodes and requires replacement of such electrodes. Accordingly, it is desirable to prevent any such contaminating flow reversal. Heretofore, proper handling of the module and appropriate pump pressures and consequent flows had to be carefully controlled in order to prevent reversal of flow, thereby increasing undesirably, the difficulty of operating the system.

It is therefore the principal object of the present invention to provide an analyte recognition system incorporating sensors, such as an array of ion selective electrode (or sensor) modules, which when operated with a reference electrode, is not subject to reversal of flows of fluid in the stream or of the upstream reference fluid into the ion-selective electrodes of the array which can carry contaminants among the sensors.

It is a still further object of the present invention to provide an improved analyte recognition system incorporating an array of ion-selective electrodes wherein contaminated flows are obviated without modification of the tubing which communicates fluids through the electrodes and without increasing the size of or requiring special packaging of the array system.

It is a still further object of the present invention to provide an ion-selective electrode analyte recognition system, wherein if conditions were to arise in which flows in reverse directions would occur, such flows are prevented and contamination of the ion-selective electrodes by such flows is also prevented.

It is a still further object of the present invention to provide an analyte recognition system which prevents leakage resulting on cross-flows which may contaminate the electrodes of the system through the use of a one way valve, especially such a valve which is of duck-bill configuration, which permits forward flow through certain electrodes, but precludes reversal of flow of fluid which may contaminate certain of these electrodes.

It is a still further object of the present invention to provide an analyte recognition system which prevents leakage due to cross-flows which may contaminate the electrodes of the system through the use of a valve which does not interfere with the obtaining of measurements so as not to diminish the accuracy of such measurements. Briefly described, the invention provides an array of chemical sensors, and particularly ion-selective electrodes, through different ones of which fluids under test flow in opposite directions via a coupling to an outlet. A one-way valve in the coupling between at least one of sensors located downstream in the flow path in one of the opposite directions, enables flow in the downstream direction to the outlet and inhibits flow in the opposite direction. Flow through another of the sensors, such as provides a reference sensor, which may be in a flow path in the opposite or upstream direction to the outlet, is inhibited and prevented by the valve from entering the sensors of the array in the downstream flow path. Contamination of the other sensors by cross-contamination carried by undesirable flow reversal in the downstream flow path is thereby avoided. Such contaminants may be released by sensors ahead of other sensors in the downstream path. When carried by a reversal of flow in the upstream direction, the contaminants can cross-contaminate the other sensors. The system responds to potentials at the sensors of the array with respect to the reference sensor, all with respect to a bias potential established on the coupling electrode. This bias potential may be at or close to ground potential, such that the coupling electrode may be referred to as a ground electrode.

The foregoing and other objects, features and advantages of the invention will become more apparent from a reading of the following description in connection with the accompanying drawings in which:

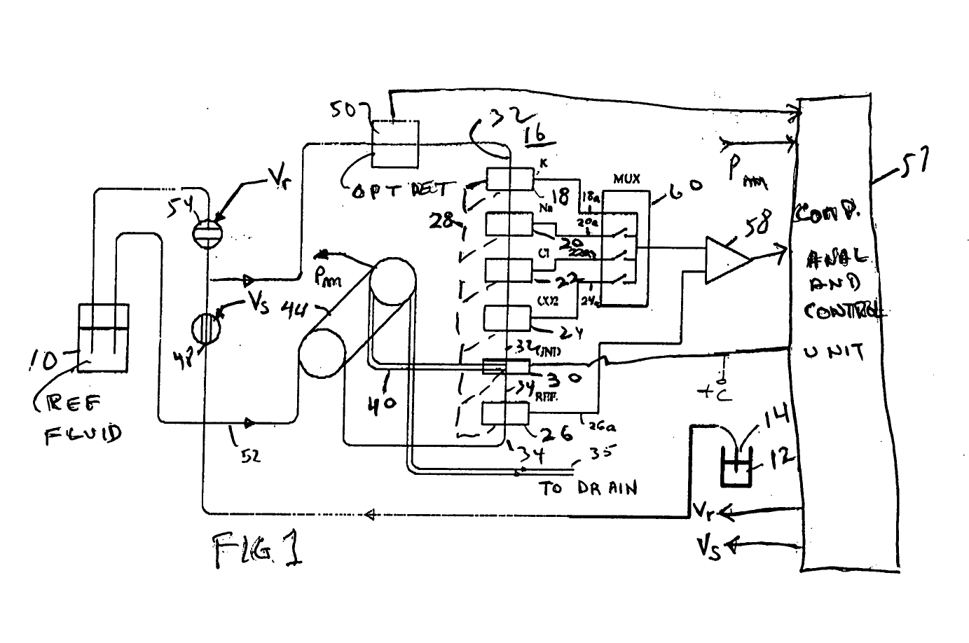

FIG. 1 is a schematic diagram of an analyte recognition system, suitable for analysis of human serum or plasma or other body fluids, having an array of ISEs which may be packaged together in an assembly or module, and in which contaminating flows such as cross-flows which may cause a reversal of flow or leak into the ion-selective electrodes is prevented;

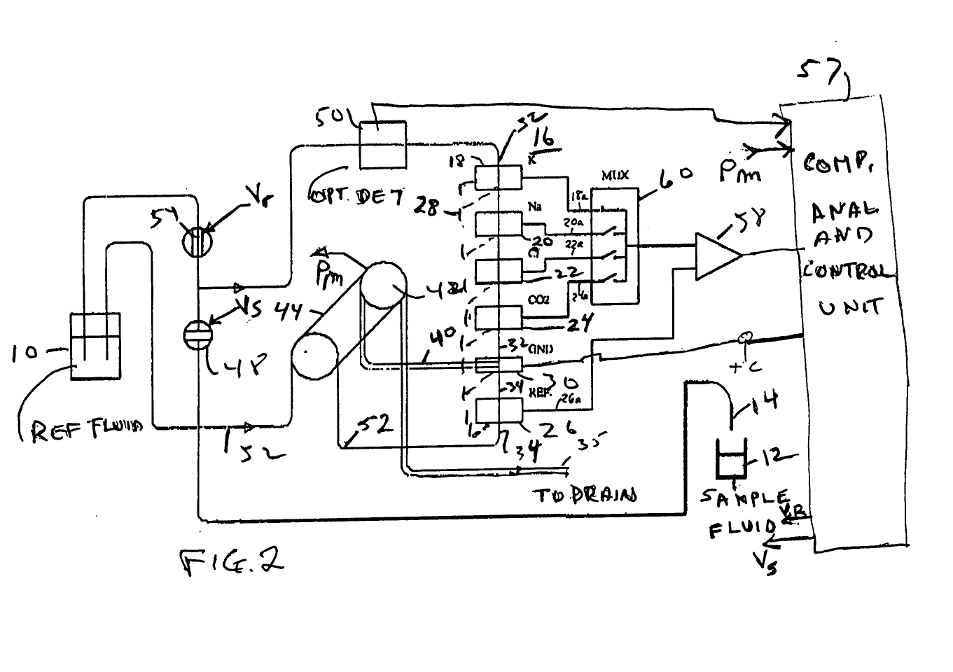

FIG. 2 is a schematic diagram similar to FIG. 1 showing another phase in the operation of the array system than is shown in FIG. 1;

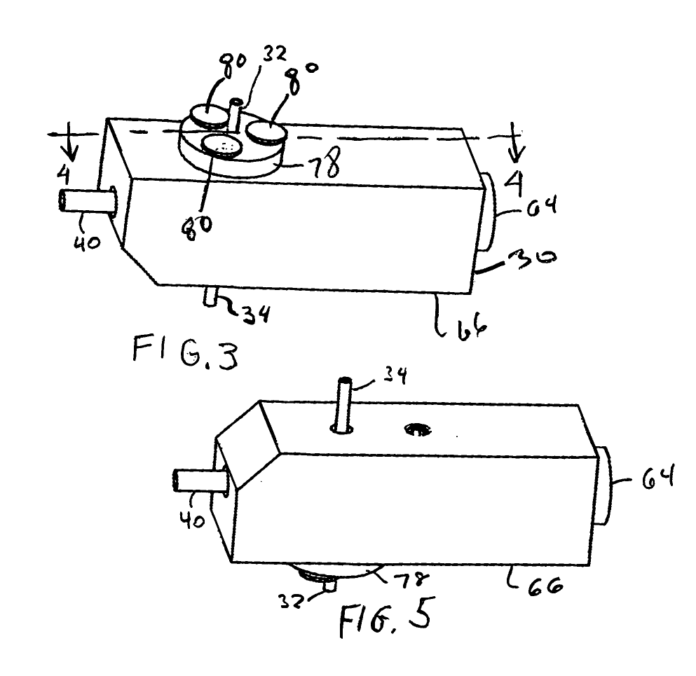

FIG. 3 is a perspective view of the ground electrode used in the array of FIGS. 1 and 2 from the top thereof;

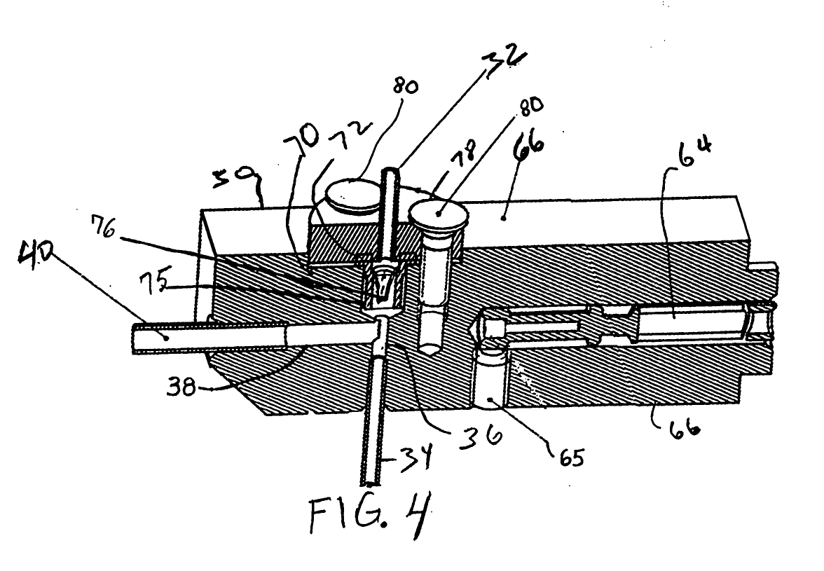

FIG. 4 is a sectional view of the ground electrode shown in FIG. 3 taken along the line 4-4 in FIG. 3; and

FIG. 5 is a perspective view of ground electrode used in the arrays of FIGS. 1 and 2 from the bottom thereof.

Referring to the drawings, there is shown in FIGS. 1 and 2 a container of reference fluid 10 and a container 12 of sample fluid which is to be analyzed. The sample fluid is extracted from the container 12 by a pipette 14.

Analysis is accomplished by a dry electrode module or pack 16 which is an assembly of an array of ISE modules or units having ion-selective electrodes (ISEs) sensors 18, 20, 22, 24, and 26 which are mechanically assembled, as indicated by the dashed line 28, together with a ground electrode 30. This ground electrode contains a one-way valve, provided in accordance with the invention, which prevents reversal of flow direction and contamination of the electrodes 18, 20, 22 and 24 by either the sample or from fluid which passes through the reference electrode 26. FIGS. 3 and 4 illustrate the ground electrode 30 in greater detail.

The pack 16 has tubing 32, of plastic material preferably such as Tygon material, which interconnects the ion-selective electrodes 18, 20, 22, and 24 and provides a downstream flow path to the ground electrode 30. Similar tubing 34 through the reference electrode 26 defines an upstream flow path to the ground electrode 30. The ground electrode 30 has openings for this tubing 32 and 34 forming legs of a T-junction 36 which interconnects to a cross-arm or leg 38 of the T-junction (FIG. 4). An outlet tube 40 also preferably of plastic material, such as Pharmed material, is entrained around a rotor 42 of a peristaltic pump 44 (FIGS. 1 and 2). The pump 44 provides suction pressure which pulls sample fluid from the container 12, via the pipette 14, to a sample valve 48 and an optical detector 50 (sometimes called a bubble detector) for the presence and absence of fluid into the tubing 32 of the array of ISEs 16. All of the tubing from the pipette 14 to the ISEs 16 may be similar, suitably transparent or translucent silicone flexible tubing.

The reference fluid is pushed along a path by the peristaltic pump 44 from the container 10 through silicone tubing 52 in an upstream direction to the reference electrode 26, and then through the T-junction 36 in the ground electrode 30, via tubing 34, and then via tubing 40 around the outside of the peristaltic pump to drain. The reference fluid has another path through a reference valve 54 through a bubble detector 50 and the ISEs 18, 20, 22, and 24 of the array 16 and the ground electrode 30 through tubing 32, and then the outlet tubing 40 to drain.

The system also includes a computer analyzer and control unit 57, which controls the valves 48 and 54 via connections Vₛ and Vᵣ. The pump 44 is controlled via connection Pₘ. Input signals are obtained from a differential amplifier 58 for analysis by the computer. The ion-selective electrode signals are multiplexed in a multiplexer 60 and outputs 18a, 20a, 22a, and 24a from ISEs 18, 20, 22 and 24, respectively, with reference 26a to the potential of the reference electrode 26 (since the reference electrode is connected to the opposite input of amplifier 58 from input to which the multiplexer 60 output is connected) are applied for analysis in the computer analyzer and control unit 57. Instead of a multiplexer 60 and a single amplifier 58, each electrode output 18a, 20a, 22a, and 24a may be applied via its own amplifier to which the reference electrode is also connected and multiplexed or strobed in an analog to digital converter in the computer analyzer 57. It is desirable in the interest of noise reduction, to operate the ground electrode 30 at a bias voltage such as indicated at +C, suitably 2.5 volts DC. Inasmuch as the fluids are conductive, the bias voltage is effectively connected to all of the electrodes 18, 20, 22, 24, and 26.

During measurements, the valves 48 and 54 are controlled by the computer analyzer 57 to be in the position shown in FIG. 1. Then the pump 44 sucks the sample up via pipette 14, valve 48, and tubing 32 through the detector 50 through the electrodes 18, 20, 22, 24, and out tubing 40 via the electrode 30 to drain. A column of fluid is thereby placed in an array of electrodes 18, 20, 22, and 24. Simultaneously, the reference fluid is pushed via tubing 52 and 34 through the reference electrode 26 and out tubing 40 via the ground electrode 30 to drain. The detector 50 indicates the presence of the column of fluid in the electrodes 18, 20, 22, and 24 by detecting the passage of the beginning of the column and the passage of the end of the column past the detector 50, before the sample fluid is exhausted from the container 12. Then the measurements are made using the multiplexer 60, amplifier 58, and the analyzer 57.

As will become apparent from FIGS. 3 and 4, reversal of flow of sample or the passage of reference fluid in the upstream direction through the ground electrode 30 into the stack or array of electrodes 18, 20, 22, and 24 is prevented by incorporation of a way valve 75 into the leg carrying the tubing 32. After the measurements are made, the system is set to the condition shown in FIG. 2, the reference fluid continues to be pumped through the reference electrode 26 via tubings 52, 34 and 40 through ground electrode 30 but is also, under suction provided by the peristaltic pump 44, drawn through the electrodes 18, 20, 22 and 24 via tubing 32, valve 54, and tubing 40, via ground electrode 30. This flow of reference fluid in the downstream direction does not carry any contaminant to the downstream electrodes, but merely prepares the electrodes for the next sample. Any remaining sample fluid is thoroughly flushed out of the electrodes 18, 20, 22, and 24 by reference solution flowing in a downstream direction prior to the next measurement. Since contaminants may be released by both Cl and CO₂ ISEs, the Cl 22 ISE and the CO₂ 24 ISE are set at the bottom of the array and away from the K 18 electrode. Fluid is never intended to flow in the upstream direction through the tubing 32 and the electrodes 18, 20, 22, and 24. Since ISE contamination occurs only when flow reversal takes place and fluid is carried upstream from the Cl 22 and the CO₂ ISE 24 to other ISE's, 18, and 20 and 22, especially the K ISE 18, flushing with reference fluid in a downstream direction does not poison the electrodes 18, 20, 22, and 24.

The ground electrode 30, as shown in FIGS. 3 and 4, has a female connecter 64 which connects the ground electrode 30 to the computer 57 where the bias +C is applied to the ground electrode. Similar connecters may be used in all of the other sensor electrodes 18, 20, 22, 24, and 26 for their signals 18a, 20a, 22a, 24a, and 26a to multiplexer 60. All of the modules containing electrodes 18, 20, 22, 24, 26 and 30 may be held in a cradle together with a circuit board to which the electrodes are connected to the multiplexer and amplifier on the board, and via the board to the computer analyzer 57.

The ground electrode 30, as shown in FIGS. 3 and 4, is a block of conductive material such as stainless steel which does not react with the sample and reference fluids. The top of the block 66 has a circular recess 70. The bottom of this recess provides a seat for the flange 72 of a duckbill valve 75 with its closure 76 or duckbill or flap tapering downwardly. A cap 78 held down by screws 80 captures the duckbill valve 75 in the block 66. Such duckbill valves 75 are available from Minivalve International, 220 E. Herman Street, Yellow Spring, Ohio, 45387, USA (e.g., their part no. DUO27.001SD). The female connector 64 is secured in the block 66 by a set screw 65 entering the block 66 from the bottom thereof.

Fluid passing in the downstream direction through the array of electrodes 18, 20, 22 and 24 and the tube 32 is not inhibited and is enabled to pass through the cross-leg 38 and out from the array via the tubing 40 to drain. On the other hand, fluid flowing through tube 34 in the upstream direction is inhibited by the duckbill valve 75 and cannot flow into the sample fluid and contaminate the electrodes 18, 20, 22, and 24. The precise location of the valve 75 is such that it does not increase to any significant extent the size of the ground electrode 30 nor give rise to any changes in the tubing or otherwise in the pack 16. Because the closure 76 essentially fills the sleeve of the duckbill valve 75, there is no propensity for the upstream flowing fluid to be retained as it passes through the outlet leg 38 without any substantial back pressure due to the presence of the valve 75.

In summary, the invention provides an analyte recognition system uses an array 16 of ion-selective electrode (ISE) sensors 18, 20, 22, and 24 each sensitive to a different ion in a downstream flow path 32 therethrough to a coupling 30 which provides a ground or bias electrode. Another flow path 34 is upstream through a reference ISE sensor 26 and the coupling 30. The coupling 30 has a flow path, provided by a sidearm, to an outlet 40 going to a drain 35 for both the upstream and downstream flow paths. In the upstream flow path, reference electrode 26 is a conduit for a reference fluid, and measurements from the other electrodes 18, 20, 22, and 24 are made with respect to the reference electrode 26. Contamination and permanent poisoning of certain of the electrodes in the downstream path may occur if reversal of the flow were to take place, or if the reference fluid flowing in the upstream path were to flow into the downstream path. Reversal of flow is prevented by inclusion of a one-way valve, desirably a duckbill valve 75 in the coupling 30 in the downstream path to the sidearm. The valve may be made of the same material as piping interconnecting the ISE sensors 18, 20, 22, and 24 in the array, and is compatible with the analyte fluids, such as may be obtained from human sera or other body fluids. The sample is normally pumped, preferably pulled, by a peristaltic pump 44 along the downstream path through the ISE sensors and the reference fluid is pushed along the upstream path by the pump. This push-pull operation takes place to provide column of fluid through the ISE sensors 18, 20, 22, and 24 while reference fluid flows through the reference electrode 26, flow is then stopped and static measurements are made of the potentials at the ISE sensors at 18a, 20a, 22a, and 24a, respectively, with respect to the reference potential at 26a. The measurements are analyzed in a computer analyzer and control unit 57 which also controls the pump 44 and detector 50 of the presence of a column of fluid in the ISE sensors. Poisoning of the ISE sensors is prevented because the duckbill valve 75 reduces the likelihood of a reversal of the normal downstream flow, and reduces flow of the reference fluid in the upstream direction through the array of ion-selective electrodes 18, 20, 22, and 24. The valve essentially fills the valve seat 70 thereof and precludes even the collection of reference fluid adjacent the downstream path through the coupling 30. The valve 75 also does not interfere with the accuracy in obtaining measurements or in carry-over from one measurement to another by any fluid retained in the valve or valve housing.

From the foregoing description, it will be apparent that there has been provided an improved analyte recognition system and preferably such a system incorporating an array of ISEs wherein cross-flows which might contaminate measurements are prevented. Variations and modification in the herein described system, within the scope of the invention, will undoubtedly suggest themselves to those skilled in the art. Accordingly, the foregoing description should be taken as illustrative and not in a limiting sense.

1. In an array of chemical sensors, through different ones of which fluids under test flow in opposite directions through a coupling to an outlet, the improvement comprising a one-way valve in said coupling between said sensor downstream in the flow path in one of said opposite directions for enabling the flow in said one direction to said outlet and inhibiting the flow in the other of said opposite directions into said sensor in the downstream flow path thereby preventing flow through at least one of said different sensors in said upward direction into said one sensor and precluding contamination of said one sensor and which does not diminish the accuracy of the measurement.

2. The invention according to claim 1 wherein said coupling is a block having a T passageway with a cross-leg of said passage to said outlet and a first passage to said one and said second passage to said another of said different sensors, said one-way valve being in said first passage disposed to enable flow therethrough in said downstream direction and inhibiting flow from said second leg into said first leg in said upstream direction.

3. The invention according to claim 2 wherein said one-way valve is a duck-bill valve having a flexible closure collar tapering in said downstream direction so that pressurized flow is enabled through said closure in said downstream direction and said closure blocks flow therethrough in said upstream direction.

4. The invention according to claim 3 wherein said sensors are electrochemical sensors, said one sensor is responsive to a compound in a sample in said downstream flow and said other sensor is a reference sensor responsive to a reference compound in said upstream flow.

5. The invention according to claim 4 wherein said sensors are modules containing ion-selective electrodes via which said flow of said sample and reference fluid pass.

6. The invention according to claim 6 wherein a plurality of said ion-selective electrode modules are selective to different ions and are sequentially connected in said array to said coupling, and said other sensor is a reference electrode.

7. The invention according to claim 6 wherein said ion selective electrode modules are respectively responsive to K, Na, Cl, and CO₂ ions and all of said sensors and said coupling are assembled together in a pack, with the CO₂ responsive electrode module as the last electrode in the downstream flow path.

8. A system comprising:
an array of ion-selective electrodes coupled to a tubing for receiving a sample fluid;
a reference ion-selective electrode; and
a ground electrode having two ports, a drain coupled to each of said ports, a one-way valve in a first of said ports for preventing back flow through said tubing, which is coupled to said first of said ports, and a second of said ports provides receiving of a reference fluid.

9. The system according to claim 8 further comprising a reference ion-selective electrode, in communication with said second of said ports, for receiving said reference fluid.

10. A coupling comprising a block having a conduit providing a fluid path forming a T between sides of said block and a junction inside said block, and a one-way valve in said conduit between said junction and one of said sides of said block.

11. The coupling according to claim 10 wherein said coupling provides an electrode, said block being of conductive material and a connection for an electric circuit to said block.

12. The coupling according to claim 11 wherein said coupling is a ground electrode and said connection is to a point of reference potential of said circuit.

13. The coupling according to claim 10 wherein said one-way valve is a duckbill valve.
